(19) United States
(12) Patent Application Publication
(10) Pub. No.: US 2003/0017288 A1
(43) Pub. Date: Jan. 23, 2003

(54) Protective device against the effects of water

(76) Inventors: Stefan Dreher, Neustadt (DE); Joachim Pakusch, Speyer (DE); Mario Sandor, Obrigheim (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/149,772

(22) PCT Filed: Dec. 22, 2000
(86) PCT No.: PCT/EP00/13163

(30) Foreign Application Priority Data
Dec. 23, 1999 (DE) 199 62 600.6

(51) Int. Cl. B32B 1/02

(52) U.S. Cl. 428/35.5

(57) ABSTRACT

The disclosure is a water containment bag comprising an at least partially water-pervious wall material enclosing a mixture of sand and a water-insoluble redispersible synthetic polymer powder having a glass transition temperature of below 50° C. It possesses improved mechanical strength and watertightness.

### DESCRIPTION

The present invention relates to a water containment bag possessing improved mechanical strength and watertightness.

A dike threatened by heavy storm tides, for example, is typically secured by using water containment devices in the form of sandbags. These typically consist of an unrottable polyester material filled with sand. Sandbags are used to secure dikes which are saturated over a large area, to build landside cofferdams or to construct emergency dams in the event of a dike burst. Stacking the sandbags initially creates a mechanically strong water barrier. Since, however, sandbags are not watertight systems, prolonged exposure to water will cause water to permeate into the sandbag. This process leads to two disadvantageous properties of sandbags and sandbag dams, namely to a gradual loss of the barrier effect, since water will increasingly migrate through the porous system, and to a gradual loss of mechanical strength, so that sandbags may be washed away by wave action or a fast moving current.

There is thus a need for sandbags with which it is possible to construct dams possessing high watertightness and mechanical strength.

There are a number of prior art proposals for modifying sandbags for this purpose. EP 0 131 312 describes sandbags filled with a mixture of sand and a superabsorbent polymer. The weight ratio of polymer to sand is 2:1 to 10:1, and preference is given to using crosslinked polymers based on (meth)acrylic acid. The bags are filled to only about 10% by volume in order that sufficient room may be available for the polymer to expand on exposure to water. Advantages of these sandbags are their intrinsic water retention capacity, their low weight (prior to exposure to water) and their enhanced tightness with regard to water after swelling.

JP-08060633 describes similar sandbags. Their water-absorbing material is a crosslinked copolymer based on N-vinylacetoamide. EP 0 072 569 discloses sandbag filling compositions comprising a water-insoluble inorganic powder (magnesium and calcium carbonate, calcium silicate, etc.) and a water-absorbent polymer containing at least 40% by weight of carboxyl-containing monomers and crosslinked with a polyamine, for example polyethyleneimine.

Sandbags filled with a mixture of a water-absorbent polymer and (organic or inorganic) fibers are described in JP-92023926.

There are also sandbags which contain water-absorbent polymers only and completely dispense with an inorganic component such as sand. JP-5918969 describes such systems based on crosslinked poly(meth)acrylic acid polymers. EP 0 368 107 nominates crosslinked polyacrylic acid, isobutene-maleic acid copolymers and hydrolyzed polyacrylonitrile, each grafted with starch. The advantages of these sandless bags over sandbags are a lower weight and a higher water absorption capacity. However, the mechanical strength of emergency dams constructed using sandless bags is comparatively low. WO 95/21876 describes the use of water-absorbent copolymers as fill material for sandbags. The copolymers consist of (1) N-isopropylacrylamide or diethylacrylamide, (2) acrylic acid or its alkali metal salts, (3) diacetoneacrylamide or acrylamide and (4) a crosslinker. The advantage of these polymers is their ability to rerelease the absorbed water at higher temperatures, conferring some reusability on the sandbags.

The use of water-absorbent polymers for filling sandbags briefly raises the barrier effect of sandbags, since the sandbags have a water absorption capacity of their own and the swelling of their contents leads to increased tightness. However, the swelling does not enhance the mechanical cohesion of the sandbags, so that the action of waves or currents can cause the sandbag dam to collapse.

It is an object of the present invention to provide a water containment device which possesses improved tightness with regard to water and also superior mechanical cohesion.

We have found that this object is achieved, surprisingly, by the use of a mixture of sand and redispersible polymer dispersion powders with or without other materials to fill sandbags in that this greatly improves their watertightness and also their mechanical cohesion.

The invention thus provides a water containment device comprising an at least partially water-pervious wall material enclosing a mixture of sand and a water-insoluble synthetic polymer powder having a glass transition temperature of below 50° C.

As water permeates into the interior of the sandbag, the polymer powder is redispersed and gradually forms a film. The resulting polymer film leads to an enhanced tightness of the polymer-sand structure with regard to water. At the same time, the individual sandbags become adhered together, which results in a high mechanical strength for the sandbag dam.

The polymer preferably has a glass transition temperature (T_{g}) in the range from −50° C. to +30° C., especially in the range from −40° C. to +20° C.

The desired glass transition temperature T_{g} may be achieved by selecting suitable types and amounts of monomers according to the formula of Fox (T. G. Fox, Bull. Amer. Physic. Soc. (Ser. II) 1, 123 (1956)) according to which the glass transition temperature T_{g} of copolymers is given to a good approximation by:

$$\frac{1}{{T}_{g}} = \frac{{X}^{1}}{{T}_{g}^{1}} + \frac{{X}^{2}}{{T}_{g}^{2}} + … + \frac{{X}^{s}}{{T}_{g}^{s}}$$

where X¹, X², . . . X^{S} are the mass fractions of the monomers, T_{g}¹, T_{g}², . . . T_{g}^{S} are the glass transition temperatures in kelvin of the respective homopolymers of the monomers 1, 2, . . . S.

The polymer may be any water-insoluble synthetic polymer satisfying the condition T_{g}<+50° C. Preferably it is a redispersible polymer powder which is obtained in particular from an aqueous dispersion of the polymers. The obtainment of such polymer powders is known to one skilled in the art. It is effected for example by spray drying or freeze drying the aqueous polymer dispersions.

Polymers useful for the invention are preferably polymerized from at least one of the following monomers:

esters of an α,β-ethylenically unsaturated C₃-C₆-monocarboxylic acid or C₄-C₈-dicarboxylic acid with a C₁-C₈-alkanol. Preference is given to esters of acrylic acid or methacrylic acid, such as methyl (meth)acrylate, ethyl (meth)acrylate, n-butyl (meth)acrylate, t-butyl (meth)acrylate, 2-ethylhexyl (meth)acrylate, etc.;

aromatic vinyl compounds, such as styrene, 4-chlorostyrene, 2-methylstyrene, etc.;

vinyl esters of aliphatic carboxylic acids, such as vinyl acetate, vinyl propionate, vinyl laurate, vinyl stearate, vinyl versatate, etc.;

olefins, such as ethylene or propylene;

conjugated diolefins, such as butadiene or isoprene;

acrylonitrile or methacrylonitrile;

vinyl chloride or vinylidene chloride.

Preferably, the polymer may also contain up to 5% by weight, preferably from 0.1 to 4% by weight, of an α,β-ethylenically unsaturated C₃-C₆-monocarboxylic acid, preferably acrylic acid or methacrylic acid, in copolymerized form.

Particularly preferably, the polymer is a homo- or copolymer of (meth)acrylates, a copolymer of at least one (meth)acrylate and styrene, a copolymer of butadiene and styrene or a copolymer of vinyl acetate and ethylene. The (meth)acrylate used is particularly preferably methyl methacrylate, ethyl acrylate, n-butyl acrylate or 2-ethylhexyl acrylate.

Preferably, the water containment device comprises ≦20% by weight, especially from 2 to 15% by weight, of polymer powder, based on the amount of sand used.

As well as the polymer powder it is possible to use further additives to fill the water containment device. It is advantageous to use water-absorbent polymers as already described in the prior art, for example superabsorbents, or to use water-retaining materials, for example polyvinyl alcohol, gums, such as xanthan gum or cellulose derivatives, especially cellulose ethers (including carboxymethylcellulose, methylcellulose) and starch. These further additives are preferably used in an amount of from 0.5 to 10% by weight, based on the sand. They improve the filming of the polymer dispersion powder, providing superior tightness and strength for the dam constructed from the water containment device.

The at least partially water-pervious wall material is generally a rottable or unrottable fabric woven from natural fibers or manufactured fibers, such as polyester. The wall material may be configured in various forms, for example as tube and, in particular, as bag.

The water containment device is advantageously produced in two steps. First, the sand, polymer dispersion powder and any further additives are added together and mixed to form a homogeneous bulk material. This is followed by the filling of the water containment device. The bulk material is preferably stored in a dry atmosphere in order that any premature filming of the powder may be prevented, which would lead to blocking. To enable the material to be stored for a limited time in a moist atmosphere, it is advantageous to add water-absorbent polymers.

The invention also provides for the use of the polymer powder as defined above for improving the mechanical strength and watertightness of water containment devices, especially sandbags. The invention further provides a method for improving the mechanical strength and watertightness of water containment devices, especially sandbags, which comprises providing a mixture of sand and a polymer powder as defined above, filling the mixture into an at least partially water-pervious wall material and arranging the water containment device in a suitable manner, for example stacking it up to create a barrier against the action of water.

The examples hereinbelow illustrate the invention.

### EXAMPLES

Mixtures were prepared using the following components:

standard sand 1 to DIN EN 196

Acronal S 430 P, a redispersible polymer dispersion powder from BASF based on a styrene-n-butyl acrylate copolymer having a glass transition temperature T_{g}=−15° C. and a minimum filming temperature of 0° C.

Vinnapas RE 545 Z, a redispersible polymer dispersion powder from Wacker based on an ethylene-vinyl acetate copolymer having a minimum filming temperature of 0° C. (glass transition temperature: −5° C.)

Aqualic CA L 400, a water-absorbent polymer from BASF based on a partially crosslinked polyacrylic acid (sodium salt)

Table 1 shows the compositions of the mixtures prepared:

TABLE 1
Compositions of polymer-sand mixtures

| | Standard | Acronal | Vinnapas | Aqualic |
|---|---|---|---|---|
| Sam- | sand 1 | S 430P | RE 545Z | CA L400 |
| ple | [% by weight] | [% by weight] | [% by weight] | [% by weight] |
| 1 | 90 | 10 | — | — |
| 2 | 90 | — | 10 | — |
| 3 | 88 | 10 | — | 2 |
| C-1 | 100 | — | — | — |
| C-2 | 30 | — | — | 70 |
| C-3 | — | — | — | 100 |

These mixtures were tested for their barrier effect with regard to water and for their mechanical strength on exposure to water.

(a) Barrier Effect with Regard to Water

Each mixture was filled into a 2000 ml glass measuring cylinder up to the 1500 ml mark and compacted by manual tapping, tamping and pressing. The sand column was subsequently covered with 500 ml of completely ion-free water colored beforehand with a few drops of bromothymol blue for better visibility of the migration of the water. The time taken by the water to permeate through the sand column to the base of the cylinder was determined. Each run was repeated 5 times to improve the precision.

(b) Mechanical Strength on Exposure to Water

For each mixture, 10 rectangular polyester textile bags 8×5 cm² in size were each filled with 200 g of the mixture and stacked up in a metal bowl. The stack was then covered with completely ion-free water (2 cm supernatant water column) for 2 hours. After the water had been poured off and the stack dried for 2 hours at room temperature, the mechanical cohesion of the bags was rated on a scale ranging from very high cohesion (impossible to separate by simply pulling) to very low (no adhesion between the bags). The results obtained are shown in Table 2.

It is apparent that the sand fills containing polymer dispersion powder led to a much enhanced tightness with regard to water. Compared with the comparative sample C-1 (no added polymer), the migration times for 10% by weight of added polymer increased more than tenfold. It is further apparent that the filming of the polymer powder results in a (desirable) blocking of the individual sandbags. The bags filled with sand only (comparative sample C-1) exhibited no mechanical cohesion whatsoever after water exposure, nor did the sample including a 70% by weight add of a water-absorbent polymer (comparative sample C-2 as per EP 0 131 312). Similarly, the bags filled with water-absorbent polymer only (comparative sample C-3 as per JP-5918969) exhibited no mechanical cohesion after water exposure.

TABLE 2
Watertightness and mechanical strength
of polymer-sand mixtures

| | Migration time | Mechanical | |
|---|---|---|---|
| Sample | [min] | strength | Notes |
| 1 | 425 ± 18 | very high | — |
| 2 | 390 ± 15 | high | — |
| 3 | 452 ± 16 | very high | — |
| C-1 | 32 ± 5 | very low | — |
| C-2 | — | very low | water completely absorbed |
| | | | in migration test |
| C-3 | — | very low | water completely absorbed |
| | | | in migration test |

We claim:

1. A water containment bag comprising an at least partially water-pervious wall material enclosing a mixture of sand and a water-insoluble redispersible synthetic polymer powder having a glass transition temperature of below 50° C.

2. The device of claim 1, wherein the polymer has a glass transition temperature in the range from −50° C. to +30° C.

3. The device of claim 2, wherein the polymer has a glass transition temperature in the range from −40° C. to +20° C.

4. The device of any of the preceding claims, wherein the polymer is selected from the group consisting of (meth)acrylate polymers, styrene-(meth)acrylate copolymers, styrene-butadiene copolymers and ethylene-vinyl acetate copolymers.

5. The device of any of the preceding claims, wherein the polymer powder is present in an amount of less than 20% by weight, based on the sand.

6. The device of claim 5, wherein the polymer powder is present in an amount of from 2 to 15% by weight, based on the sand.

7. The device of any of the preceding claims, further comprising a superabsorbent polymer.

8. The device of any of the preceding claims, further comprising a water-retaining material selected from the group consisting of polyvinyl alcohol, xanthan, starch and cellulose derivatives.

9. The device of either of claims 7 and 8, wherein the superabsorbent polymer and/or the water-retaining material is present in an amount in each case of up to 10% by weight, based on the sand.

10. The method of using a polymer powder as defined in any of claims 1 to 9 to improve the mechanical strength and watertightness of water containment bags, especially sandbags.
